(19) United States
(12) Patent Application Publication
(10) Pub. No.: US 2026/0178655 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventors: Satoshi MIYAKE, Toyota-shi (JP); Tetsuya Hashimoto, Tokyo (JP); Mitsuhiro Mabuchi, Tokyo (JP)

(73) Assignee: TOYOTA JIDOSHA KABUSHIKI KAISHA, Toyota-shi (JP)

(21) Appl. No.: 19/371,396

(22) Filed: Oct. 28, 2025

(30) Foreign Application Priority Data
Dec. 24, 2024 (JP) 2024-227581

(51) Int. Cl. G06F 16/535; G06F 16/538; G06F 16/583; G06F 16/901

(52) U.S. Cl. CPC G06F 16/535; G06F 16/538; G06F 16/5838; G06F 16/5854; G06F 16/9024

(57) ABSTRACT

An information processing device includes: a storage unit configured to store image data in association with a graph structure extracted from the image data; an acquisition unit configured to acquire, as a search key, the graph structure entered by a user; a search unit configured to perform a search of the graph structures stored in the storage unit using the search key; and an output unit configured to output, as a search result, image data associated with the graph structure having a degree of similarity to the search key.

### CROSS-REFERENCE TO RELATED APPLICATION

This application claims priority to Japanese Patent Application No. 2024-227581

filed on Dec. 24, 2024. The disclosure of the above-identified application, including the specification, drawings, and claims, is incorporated by reference herein in its entirety.

### BACKGROUND

### 1. Technical Field

The present disclosure relates to the technical field of information processing

devices.

2. Description of Related Art As an example of this type of device, a system has been proposed in which a large

language model (LLM) is used to generate query data based on documents, and pairs of the documents and the query data are used to train a retrieval model for a dialogue bot (see Japanese Unexamined Patent Application Publication No. 2023-076413 (JP 2023-076413 A)).

### SUMMARY

A graph neural network (GNN) is one known machine learning model designed to handle data with a graph structure. GNNs have been proposed for use in, for example, application such as classification and regression. On the other hand, no concrete proposals have yet been made for searching for images using a graph structure, and there remains room for improvement.

The present disclosure has been made in view of the above issue, and an object thereof is to provide an information processing device capable of appropriately searching for image data.

An information processing device according to one aspect of the present disclosure includes: a storage unit configured to store image data in association with a graph structure extracted from the image data; an acquisition unit configured to acquire, as a search key, the graph structure entered by a user; a search unit configured to perform a search of the graph structures stored in the storage unit using the search key; and an output unit configured to output, as a search result, image data associated with the graph structure having a degree of similarity to the search key.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of an information processing device according to an embodiment;

FIG. 2 is a block diagram illustrating a functional configuration of the information processing device according to the embodiment;

FIG. 3 is a flowchart illustrating a storage operation performed by the information processing device according to the embodiment;

FIG. 4 is a plan view illustrating an example of image data and a graph structure to be stored; and

FIG. 5 is a flowchart illustrating a search operation performed by the information processing device according to the embodiment.

### DETAILED DESCRIPTION OF EMBODIMENTS

An embodiment of an information processing device will be described below with reference to the drawings.

### Hardware Configuration

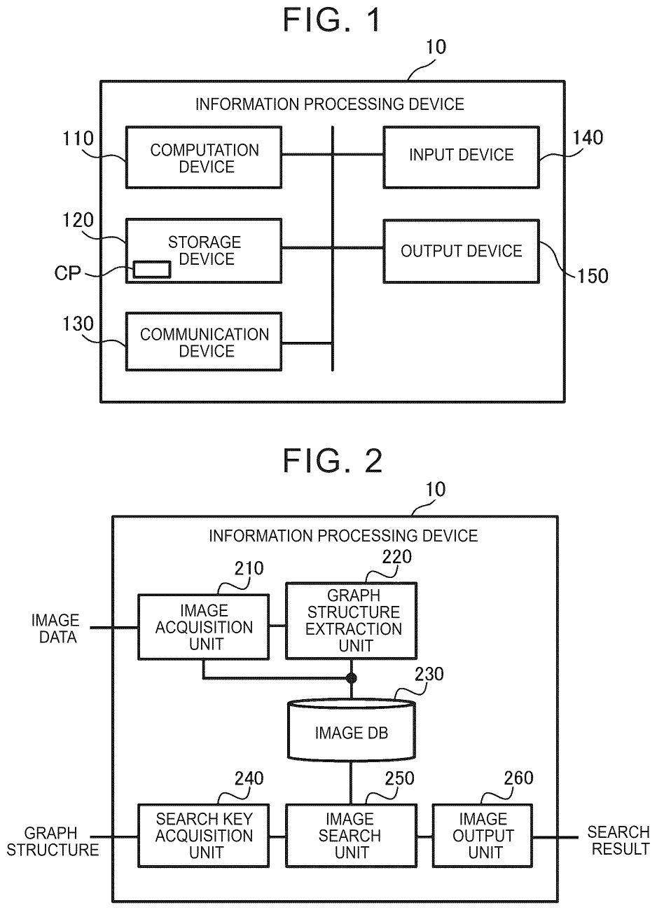

First, a hardware configuration of the information processing device according to the embodiment will be described with reference to FIG. 1. FIG. 1 is a block diagram illustrating the hardware configuration of the information processing device according to the embodiment.

In FIG. 1, an information processing device 10 according to the embodiment includes a computation device 110, a storage device 120, a communication device 130, an input device 140, and an output device 150. The computation device 110, the storage device 120, the communication device 130, the input device 140, and the output device 150 are connected to each other via a data bus.

The computation device 110 is configured to execute various computational processes in the information processing device 10. The computation device 110 may include a processor. The computation device 110 may include a single processor or may include a plurality of processors. In other words, the computation device 110 may include one or more processors. The processor may be a multicore processor. When the computation device 110 includes a single processor that is a multicore processor, the computation device 110 can logically be regarded as including a plurality of processors.

The processor included in the computation device 110 may be, for example, at least one of the following: a central processing unit (CPU), a graphics processing unit (GPU), a field programmable gate array (FPGA), and a tensor processing unit (TPU).

The storage device 120 may be, for example, at least one of the following: a random access memory (RAM), a read-only memory (ROM), a hard disk drive, a magneto-optical disk drive, a solid-state drive (SSD), and an optical disk array. That is, the storage device 120 may be implemented using a single device or may be implemented using a plurality of devices.

The storage device 120 is capable of storing desired data. The storage device 120 may store a computer program CP that is executed by the computation device 110. When the computation device 110 is executing the computer program CP, the storage device 120 may temporarily store data temporarily used by the computation device 110.

The computer program CP may be recorded on a computer-readable and non-transitory recording medium. In this case, the computer program CP may be stored in the storage device 120 by reading the recording medium using a recording medium reader (not shown) included in the information processing device 10. At least one of the following media may be used as the recording medium: an optical disk, a magnetic medium, a magneto-optical disk, a semiconductor memory, and any other medium capable of storing programs. The computer program CP may be acquired from a device (not shown) external to the information processing device 10 via the communication device 130. In other words, the computer program CP may be downloaded from an external device to the storage device 120 of the information processing device 10.

The computation device 110 (e.g., a processor), together with the storage device 120 storing the computer program CP (in other words, together with the storage device 120 and the computer program CP stored in the storage device 120), may execute processing to be performed by the information processing device 10. For example, logical functional blocks for executing the processing to be performed by the information processing device 10 may be implemented within the computation device 110 (e.g., within the processor) by the computation device 110 executing the computer program CP.

The communication device 130 is configured to communicate with a device external to the information processing device 10. The communication device 130 may perform wired communication or wireless communication.

The input device 140 is a device capable of receiving information input from outside to the information processing device 10. The input device 140 may include an operation device operable by a user of the information processing device 10 (e.g., a keyboard, a mouse, a touch panel, etc.). The input device 140 may include a recording medium reader capable of reading information recorded on a recording medium (such as a Universal Serial Bus (USB) memory) that is attachable to and detachable from the information processing device 10. When information is input to the information processing device 10 via the communication device 130 (in other words, when the information processing device 10 acquires information via the communication device 130), the communication device 130 may serve as an input device.

The output device 150 is a device capable of outputting information to the outside of the information processing device 10. The output device 150 may include a display device capable of outputting visual information such as text or images as the output information. The output device 150 may include a speaker capable of outputting auditory information such as sound as the output information. The output device 150 may be configured to output the above information (e.g., control information for other devices) to other devices. The output device 150 may be capable of outputting information to a recording medium that is attachable to and detachable from the information processing device 10, such as a USB memory. When the information processing device 10 outputs information via the communication device 130, the communication device 130 may serve as an output device.

### Functional Configuration

Next, a functional configuration of the information processing device 10 according to the embodiment will be described with reference to FIG. 2. FIG. 2 is a block diagram illustrating the functional configuration of the information processing device according to the embodiment.

In FIG. 2, the information processing device 10 is configured as a device that searches for images based on a graph structure entered by the user. The information processing device 10 includes, as components for implementing its functions, an image acquisition unit 210, a graph structure extraction unit 220, an image database (DB) 230, a search key acquisition unit 240, an image search unit 250, and an image output unit 260. Each of the image acquisition unit 210, the graph structure extraction unit 220, the search key acquisition unit 240, the image search unit 250, and the image output unit 260 may be a processing block implemented by the computation device 110 described above. The image DB 230 may be a database implemented by the storage device 120 described above.

The image acquisition unit 210 is configured to acquire image data. For example, the image acquisition unit 210 may be configured to acquire image data entered by the user. Alternatively, the image acquisition unit 210 may be configured to automatically collect and acquire image data.

The graph structure extraction unit 220 is configured to extract a graph structure from the image data acquired by the image acquisition unit 210. The method for extracting a graph structure from image data is not particularly limited. For example, the graph structure extraction unit 220 may extract a graph structure from an image using a pre-trained model. This model may be a model trained to take image data as input and output a graph structure.

The image DB 230 is configured to store images acquired by the image acquisition unit 210 and graph structures extracted by the graph structure extraction unit 220. More specifically, the image DB 230 is configured to store image data and the graph structure extracted from that image data in association with each other. The image DB may alternatively be configured to store the image data in association with features representing the graph structure.

The search key acquisition unit 240 is configured to acquire a search key entered by the user (i.e., a condition for searching for image data). The search key acquisition unit 240 acquires a graph structure as the search key.

The image search unit 250 searches the image data stored in the image DB using the search key acquired by the search key acquisition unit 240. Specifically, the image search unit 250 compares the graph structure acquired as the search key with the graph structures stored in the image DB 230, identifies a graph structure(s) having high similarity, and outputs, as the search result, the image data stored in association with the graph structure(s). For example, the image search unit 250 may output, as the search result, the image data associated with the graph structure having the highest similarity to the search key. Alternatively, the image search unit 250 may output, as the search result, the image data associated with graph structures whose similarity to the search key is greater than or equal to a predetermined threshold. The image search unit 250 may also perform the search using features representing the graph structure acquired as the search key.

The image output unit 260 is configured to output, to the user, the image data output as the search result by the image search unit 250. For example, the image output unit 260 may be configured to display, on a display, the image data that is the search result. The image output unit 260 may also output, together with the image data that is the search result, the graph structure associated with the image. For example, the image output unit 260 may display the image data and the graph structure side by side on the display.

### Storage Operation

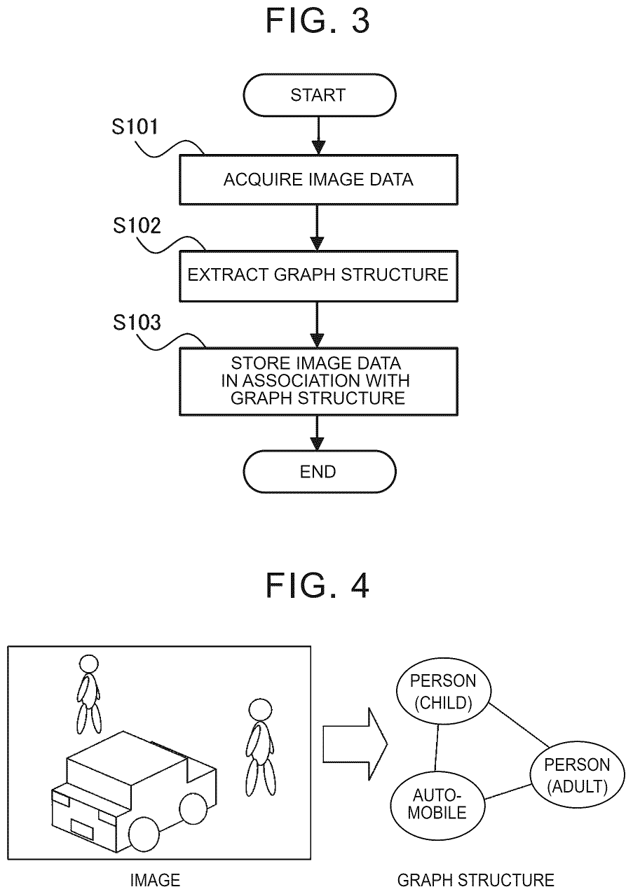

Next, a storage operation performed by the information processing device 10 according to the embodiment (that is, an operation performed when storing image data in association with a graph structure) will be described with reference to FIGS. 3 and 4. FIG. 3 is a flowchart illustrating the storage operation performed by the information processing device according to the embodiment. FIG. 4 is a plan view illustrating an example of image data and a graph structure to be stored.

As shown in FIG. 3, when the storage operation performed by the information processing device 10 according to the embodiment is started, the image acquisition unit 210 first acquires an image (step S101). The graph structure extraction unit 220 then extracts a graph structure from the image acquired by the image acquisition unit 210 (step S102).

Thereafter, the image DB 230 stores the image acquired by the image acquisition unit 210 and the graph structure extracted by the graph structure extraction unit 220 in association with each other (step S103). By repeatedly executing the processes of steps S101 to S103 described above, a plurality of pairs of image data and graph structures is accumulated in the image DB 230.

As shown in FIG. 4, for example, it is assumed that image data including an automobile and two persons is acquired. In this case, from the image data, a graph structure is extracted that includes information on the positional relationship between the automobile and the two persons (an adult and a child) and information on the shapes and colors of the automobile and the persons. Such a pair of image data and a graph structure is stored in the image DB 230.

### Search Operation

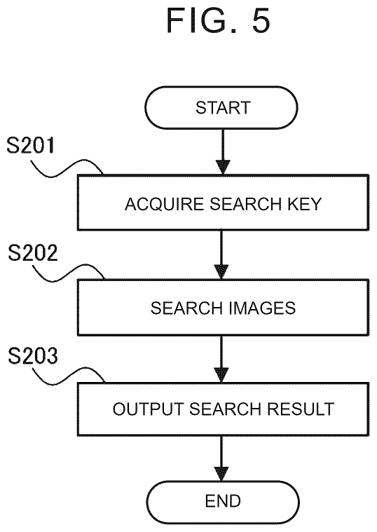

Next, a search operation performed by the information processing device 10 according to the embodiment (that is, an operation performed when searching for image data using a search key) will be described with reference to FIG. 5. FIG. 5 is a flowchart illustrating the search operation performed by the information processing device according to the embodiment.

As shown in FIG. 5, when the storage operation of the information processing device 10 according to the embodiment is started, the search key acquisition unit 240 first acquires, from the user, a graph structure that is a search key (step S201). The image search unit 250 then searches the image data stored in the image DB 230 using the graph structure acquired by the search key acquisition unit 240 (step S202).

Thereafter, the image output unit 260 outputs the search result obtained by the image search unit 250 (step S203). That is, the image output unit 260 outputs, to the user, image data that matches the search key. When the search result includes a plurality of pieces of image data, the image output unit 260 may output the plurality of pieces of image data.

### Technical Effects

Next, technical effects obtained by the information processing device 10 according to the embodiment will be described.

As described with reference to FIGS. 1 to 5, in the information processing device 10 according to the embodiment, image data and a graph structure extracted from the image data are stored in association with each other. Then, the stored image data is searched using a graph structure entered by a user. By searching images in this way using a graph structure, it is possible to accurately extract desired image data from among the stored image data. For example, images can be searched while taking into account various features such as the positional relationships among multiple objects included in the graph structure, and the shapes and colors of the objects.

Aspects of the disclosure derived from the above embodiment will be described below.

An information processing device according to one aspect of the present disclosure includes: a storage unit configured to store image data in association with a graph structure extracted from the image data; an acquisition unit configured to acquire, as a search key, the graph structure entered by a user; a search unit configured to perform a search of the graph structures stored in the storage unit using the search key; and an output unit configured to output, as a search result, image data associated with the graph structure having a degree of similarity to the search key. In the above embodiment, the “image DB 230” is an example of the “storage unit,” the “search key acquisition unit 240” is an example of the “acquisition unit,” the “image search unit 250” is an example of the “search unit,” and the “image output unit 260” is an example of the “output unit.”

In the information processing device according to the above aspect, the search unit may be configured to perform the search based on a positional relationship of a plurality of objects represented by the graph structure. In this way, it becomes possible to search images more appropriately based on the positional relationship of objects included in the graph structure.

In the information processing device according to the above aspect, the search unit may be configured to perform the search based on either or both of a shape and a color of an object represented by the graph structure. In this way, it becomes possible to search images more appropriately based on either or both of a shape and a color of an object included in the graph structure.

The present disclosure is not limited to the embodiment described above, and various modifications can be made as appropriate without departing from the gist or spirit of the disclosure as understood from the claims and the entire specification. Information processing devices incorporating such modifications are also within the technical scope of the present disclosure.

What is claimed is:

1. An information processing device comprising:
a storage unit configured to store image data in association with a graph structure extracted from the image data;
an acquisition unit configured to acquire, as a search key, the graph structure entered by a user;
a search unit configured to perform a search of the graph structures stored in the storage unit using the search key; and
an output unit configured to output, as a search result, image data associated with the graph structure having a degree of similarity to the search key.

2. The information processing device according to claim 1, wherein the search unit is configured to perform the search based on a positional relationship of a plurality of objects represented by the graph structure.

3. The information processing device according to claim 1, wherein the search unit is configured to perform the search based on either or both of a shape and a color of an object represented by the graph structure.
